(19) United States
(12) Patent Application Publication
(10) Pub. No.: US 2026/0353310 A1
(43) Pub. Date: Nov. 5, 2026

(54) POWER ADJUSTMENT METHOD AND APPARATUS, ELECTRONIC DEVICE, AND COMPUTER-READABLE STORAGE MEDIUM

(71) Applicant: SANECHIPS TECHNOLOGY CO., LTD., Shenzhen (CN)

(72) Inventor: Weiwei SHANGGUAN, Shenzhen, Guangdong (CN)

(21) Appl. No.: 19/484,992

(22) PCT Filed: Apr. 8, 2024
(86) PCT No.: PCT/CN2024/086535

§ 371 Date: Nov. 17, 2025

(30) Foreign Application Priority Data
May 17, 2023 (CN) 202310560199.2

(51) Int. Cl. H04W 52/36; H04W 52/08

(52) U.S. Cl. CPC H04W 52/367; H04W 52/08

(57) ABSTRACT

A power adjustment method includes: receiving an adjustment instruction issued by a base station, and determining a target first power based on the adjustment instruction and a first power of a terminal; determining a second power of the terminal; determining whether a third power of the terminal is within a limitation range based on the target first power and the second power; in response to the third power going beyond the limitation range, determining a rapid power adjustment amount based on an adjustment range of a final transmit power of the terminal, the first power, and the second power; and determining the final transmit power of the terminal based on the rapid power adjustment amount, the target first power, and the second power.

### CROSS REFERENCE TO RELATED APPLICATIONS

The present disclosure claims the priority to Chinese Patent Application No. 202310560199.2 filed on May 17, 2023, the contents of which are incorporated herein by reference in their entirety.

### TECHNICAL FIELD

Embodiments of the present disclosure relate to the technical field of communications, and in particular, to a power adjustment method, a power adjustment apparatus, an electronic device, and a computer-readable storage medium.

### BACKGROUND

Different calculation formulas are used for powers of different channels in uplink power closed-loop control calculation of the New Radio (NR), and it is specified in section 7.1.1 of 3 GPP 38.213 that a final transmit power of a terminal cannot go beyond a range from a minimum value to a maximum value of a transmit power. The final transmit power of the terminal includes a closed-loop power and other power parameters such as path loss and an expected received target power, such that it cannot be ensured that the final transmit power of the terminal is within an adjustment range during a base station adjusting the transmit power of the terminal by adjusting the closed-loop power of the terminal, and in a case where the final transmit power of the terminal is beyond the adjustment range, the closed-loop power of the terminal cannot be adjusted based on an adjustment instruction issued by the base station, that is, the adjustment instruction issued by the base station cannot take effect immediately.

### SUMMARY

In a first aspect, an embodiment of the present disclosure provides a power adjustment method, including: receiving an adjustment instruction issued by a base station, and determining a target first power based on the adjustment instruction and a first power of a terminal; determining a second power of the terminal; determining whether a third power of the terminal is within a limitation range based on the target first power and the second power; in response to the third power going beyond the limitation range, determining a rapid power adjustment amount based on an adjustment range of a final transmit power of the terminal, the first power, and the second power; and determining the final transmit power of the terminal based on the rapid power adjustment amount, the target first power, and the second power, so as to enable the final transmit power to be within the adjustment range of the final transmit power.

In a second aspect, an embodiment of the present disclosure provides a power adjustment apparatus, including: a power determination module, configured to receive an adjustment instruction issued by a base station, and determine a target first power based on the adjustment instruction and a first power of a terminal; a rapid-power-adjustment-amount determination module, configured to determine a second power of the terminal, determine whether a third power of the terminal is within a limitation range based on the target first power and the second power, and determine, in response to the third power going beyond the limitation range, a rapid power adjustment amount based on an adjustment range of a final transmit power of the terminal, the first power, and the second power; and a transmit-power determination module, configured to determine the final transmit power of the terminal based on the rapid power adjustment amount, the target first power, and the second power, so as to enable the final transmit power to be within the adjustment range of the final transmit power.

In a third aspect, an embodiment of the present disclosure provides an electronic device, including: at least one processor; and a storage device having stored thereon at least one computer program which, when executed by the at least one processor, causes the at least one processor to implement the power adjustment method described above.

In a fourth aspect, an embodiment of the present disclosure provides a computer-readable storage medium having stored thereon a computer program which, when executed by a processor, causes the processor to implement the power adjustment method described above.

### BRIEF DESCRIPTION OF DRAWINGS

FIG. 1 is a flowchart illustrating a power adjustment method according to an embodiment of the present disclosure;

FIG. 2 is a flowchart illustrating a power adjustment method in Example 1 according to an embodiment of the present disclosure;

FIG. 3 is a flowchart illustrating a power adjustment method in Example 2 according to an embodiment of the present disclosure;

FIG. 4 is a flowchart illustrating a power adjustment method in Example 3 according to an embodiment of the present disclosure;

FIG. 5 is a flowchart illustrating a power adjustment method in Example 4 according to an embodiment of the present disclosure;

FIG. 6 is a block diagram of a power adjustment apparatus according to an embodiment of the present disclosure; and

FIG. 7 is a block diagram of an electronic device according to an embodiment of the present disclosure.

### DETAIL DESCRIPTION OF EMBODIMENTS

In order to enable those of ordinary skill in the art to better understand the technical solutions of the present disclosure, a power adjustment method, a power adjustment apparatus, an electronic device, and a computer-readable medium provided in the present disclosure are described in detail below with reference to the drawings.

Exemplary embodiments will be described more fully below with reference to the drawings, but the exemplary embodiments described herein may be embodied in different forms and should not be interpreted as being limited to those described herein, The embodiments are provided to make the present disclosure thorough and complete, and enable those of ordinary skill in the art to fully understand the scope of the present disclosure.

The embodiments described herein and the features therein may be combined with one another if no conflict is incurred.

The term “and/or” used herein includes any and all combinations of at least one associated listed item.

The terms used herein are merely used to describe specific embodiments, and are not intended to limit the present disclosure. As used herein, “a” and “the” which indicate a singular form are intended to include a plural form, unless otherwise expressly stated in the context. It should be further understood that the terms “include/comprise”, “be made of/consist of” or the like used herein each indicate the presence of the described features, integers, operations, elements and/or components, but do not exclude the presence or addition of at least one another feature, integer, operation, element, component and/or combinations thereof.

Unless otherwise defined, all terms (including technical terms and scientific terms) used herein have the same meaning as commonly understood by those of ordinary skill in the art. It should be further understood that terms, such as those defined in commonly used dictionaries, each should be interpreted as having a meaning that is consistent with a meaning in the context of the related technology and the background of the present disclosure, and should not be interpreted in an idealized or overly formal sense unless expressly so defined herein.

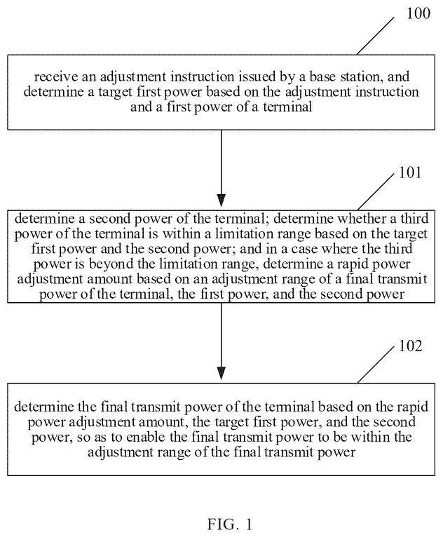

FIG. 1 is a flowchart illustrating a power adjustment method according to an embodiment of the present disclosure.

In a first aspect, referring to FIG. 1, an embodiment of the present disclosure provides a power adjustment method, including the following operations 100 to 102.

At operation 100, an adjustment instruction issued by a base station is received, and a target first power is determined based on the adjustment instruction and a first power of a terminal.

In some exemplary implementations, the first power may be a closed-loop power or a ramp power.

In some exemplary implementations, the closed-loop power refers to a power to be subjected to a closed-loop control.

In some exemplary implementations, in a case where the first power is the closed-loop power, determining the target first power based on the adjustment instruction and the first power of the terminal includes: determining a target closed-loop power based on the adjustment instruction and the closed-loop power of the terminal.

In some exemplary implementations, the ramp power refers to a power to be subjected to power ramping.

In some exemplary implementations, in a case where the first power is the ramp power, determining the target first power based on the adjustment instruction and the first power of the terminal includes: based on the adjustment instruction, adding the ramp power of the terminal and a boost power to obtain a target ramp power.

At operation 101, a second power of the terminal is determined; whether a third power of the terminal is within a limitation range is determined based on the target first power and the second power; and in a case where the third power is beyond the limitation range, a rapid power adjustment amount is determined based on an adjustment range of a final transmit power of the terminal, the first power, and the second power.

In some exemplary implementations, the second power is an accumulated value of first other powers except the closed-loop power, the first power is the closed-loop power, and the target first power is the target closed-loop power.

In some exemplary implementations, the second power is an accumulated value of second other powers except the ramp power, the first power is the ramp power, and the target first power is the target ramp power.

In some exemplary implementations, the third power is the target closed-loop power, and the limitation range is an adjustment range of the closed-loop power.

In some exemplary implementations, the third power is the target ramp power, and the limitation range is an adjustment range of the ramp power.

In some exemplary implementations, the third power is a sum of the target first power and the second power, and the limitation range is the adjustment range of the final transmit power of the terminal.

In some exemplary implementations, the third power is a sum of the target closed-loop power and the second power, and the limitation range is the adjustment range of the final transmit power of the terminal.

In some exemplary implementations, the third power is a sum of the target ramp power and the second power, and the limitation range is the adjustment range of the final transmit power of the terminal.

In some exemplary implementations, adjustment ranges of final transmit powers of different terminals may be the same or different, which is determined based on capabilities of the terminals.

In some exemplary implementations, determining whether the third power of the terminal is within the limitation range based on the target first power and the second power includes: determining the limitation range based on the second power and the adjustment range of the final transmit power of the terminal; and determining whether the target first power is within the limitation range.

In some exemplary implementations, determining the limitation range based on the second power and the adjustment range of the final transmit power of the terminal includes: determining a minimum value of the limitation range to be a difference between a minimum value of the adjustment range of the final transmit power of the terminal and the second power, and determining a maximum value of the limitation range to be a difference between a maximum value of the adjustment range of the final transmit power of the terminal and the second power.

In some exemplary implementations, in a case where the limitation range is the adjustment range of the closed-loop power, a minimum value of the adjustment range of the closed-loop power is determined to be the difference between the minimum value of the adjustment range of the final transmit power of the terminal and the second power, and a maximum value of the adjustment range of the closed-loop power is determined to be the difference between the maximum value of the adjustment range of the final transmit power of the terminal and the second power.

In some exemplary implementations, in a case where the limitation range is the adjustment range of the ramp power, a minimum value of the adjustment range of the ramp power is determined to be the difference between the minimum value of the adjustment range of the final transmit power of the terminal and the second power, and a maximum value of the adjustment range of the ramp power is determined to be the difference between the maximum value of the adjustment range of the final transmit power of the terminal and the second power.

In some exemplary implementations, determining whether the third power of the terminal is within the limitation range based on the target first power and the second power includes: determining the third power based on the target first power and the second power; and determining whether the third power is within the limitation range.

In some exemplary implementations, in a case where the third power is the sum of the target first power and the second power, determining whether the third power of the terminal is within the limitation range based on the target first power and the second power includes: determining the third power based on the target first power and the second power; and determining whether the third power is within the adjustment range of the final transmit power of the terminal.

In some exemplary implementations, in a case where the third power is the sum of the target closed-loop power and the second power, determining whether the third power of the terminal is within the limitation range based on the target first power and the second power includes: determining the third power based on the second power and the target closed-loop power; and determining whether the third power is within the adjustment range of the final transmit power of the terminal.

In some exemplary implementations, in a case where the third power is the sum of the target ramp power and the second power, determining whether the third power of the terminal is within the limitation range based on the target first power and the second power includes: determining the third power based on the first power and the target ramp power; and determining whether the third power is within the adjustment range of the final transmit power of the terminal.

In some exemplary implementations, the third power is determined to be the sum of the target first power and the second power.

In some exemplary implementations, determining the rapid power adjustment amount based on the adjustment range of the final transmit power of the terminal, the first power, and the second power includes: determining the rapid power adjustment amount to be a difference of the minimum value of the adjustment range of the final transmit power of the terminal from a sum of the first power and the second power.

In some exemplary implementations, in a case where the third power is less than the minimum value of the limitation range, determining the rapid power adjustment amount based on the adjustment range of the final transmit power of the terminal, the first power, and the second power includes: determining the rapid power adjustment amount to be the difference of the minimum value of the adjustment range of the final transmit power of the terminal from the sum of the first power and the second power.

In some exemplary implementations, after the rapid power adjustment amount is obtained, a sum of the rapid power adjustment amount and the target first power is to be used as an adjusted object in response to receiving the adjustment instruction from the base station next time, that is, in response to receiving the adjustment instruction from the base station next time, the sum of the rapid power adjustment amount and the target first power, obtained based on the adjustment instruction, is to be used as a next target first power.

In some exemplary implementations, determining the rapid power adjustment amount based on the adjustment range of the final transmit power of the terminal, the first power, and the second power includes: determining the rapid power adjustment amount to be a difference of the maximum value of the adjustment range of the final transmit power of the terminal from a sum of the first power and the second power.

In some exemplary implementations, in a case where the third power is greater than the maximum value of the limitation range, determining the rapid power adjustment amount based on the adjustment range of the final transmit power of the terminal, the first power, and the second power includes: determining the rapid power adjustment amount to be the difference of the maximum value of the adjustment range of the final transmit power of the terminal from the sum of the first power and the second power.

In some exemplary implementations, after the rapid power adjustment amount is obtained, a difference between the rapid power adjustment amount and the target first power is to be used as an adjusted object in response to receiving the adjustment instruction from the base station next time, that is, in response to receiving the adjustment instruction from the base station next time, the difference between the rapid power adjustment amount and the target first power, obtained based on the adjustment instruction, is to be used as a next target first power.

At operation 102, the final transmit power of the terminal is determined based on the rapid power adjustment amount, the target first power, and the second power, so as to enable the final transmit power to be within the adjustment range of the final transmit power.

In some exemplary implementations, determining the final transmit power of the terminal based on the rapid power adjustment amount, the target first power, and the second power includes: determining the final transmit power of the terminal to be a sum of the rapid power adjustment amount, the target first power, and the second power.

In some exemplary implementations, in a case where the rapid power adjustment amount is determined to be the difference of the minimum value of the adjustment range of the final transmit power of the terminal from the sum of the first power and the second power, determining the final transmit power of the terminal based on the rapid power adjustment amount, the target first power, and the second power includes: determining the final transmit power of the terminal to be the sum of the rapid power adjustment amount, the target first power, and the second power.

In some exemplary implementations, determining the final transmit power of the terminal based on the rapid power adjustment amount, the target first power, and the second power includes: determining the final transmit power of the terminal to be a difference of the rapid power adjustment amount from a sum of the target first power and the second power.

In some exemplary implementations, in a case where the rapid power adjustment amount is determined to be the difference of the maximum value of the adjustment range of the final transmit power of the terminal from the sum of the first power and the second power, determining the final transmit power of the terminal based on the rapid power adjustment amount, the target first power, and the second power includes: determining the final transmit power of the terminal to be the difference of the rapid power adjustment amount from the sum of the target first power and the second power.

In some exemplary implementations, in a case where the third power is within the limitation range, the final transmit power of the terminal is determined based on the target first power and the second power of the terminal.

In some exemplary implementations, determining the final transmit power of the terminal based on the target first power and the second power of the terminal includes: determining the final transmit power of the terminal to be the sum of the target first power and the second power of the terminal.

With the power adjustment method provided in the embodiment of the present disclosure, by adjusting the final transmit power of the terminal based on the rapid power adjustment amount, the final transmit power is within the adjustment range thereof, and the terminal can quickly respond to a power adjustment strategy of the base station.

In order to present specific implementations of the power adjustment method provided in the embodiment of the present disclosure more clearly, several examples are listed and illustrated below in detail, but the listed examples are not intended to limit the scope of the embodiment of the present disclosure.

### Example 1

In the present example, a power calculation for a Physical Uplink Shared Channel (PUSCH) is taken as an example to illustrate the power adjustment method provided in the embodiment of the present disclosure, and a power calculation process for the PUSCH is to be under a closed-loop control, so that the final transmit power of the terminal is a sum of a closed-loop power and an accumulated value of first other powers except the closed-loop power.

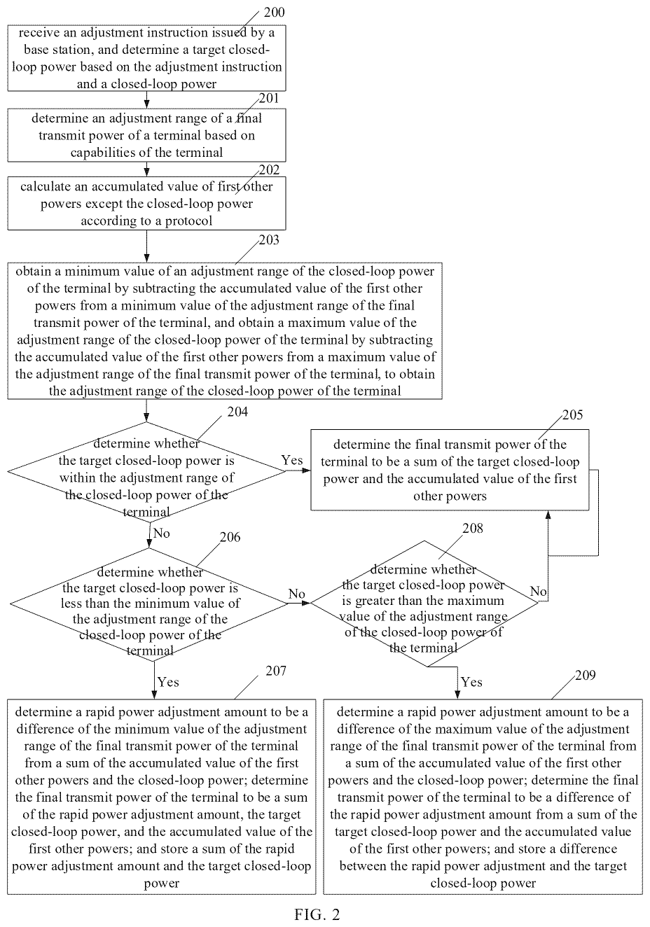

As shown in FIG. 2, a power adjustment procedure for the PUSCH includes the following operations 200 to 209.

At operation 200, an adjustment instruction issued by a base station is received, and a target closed-loop power is determined based on the adjustment instruction and a closed-loop power.

At operation 201, an adjustment range of a final transmit power of a terminal is determined based on capabilities of the terminal.

At operation 202, an accumulated value of first other powers except the closed-loop power is calculated according to a protocol.

At operation 203, a minimum value of an adjustment range of the closed-loop power of the terminal is obtained by subtracting the accumulated value of the first other powers from a minimum value of the adjustment range of the final transmit power of the terminal, and a maximum value of the adjustment range of the closed-loop power of the terminal is obtained by subtracting the accumulated value of the first other powers from a maximum value of the adjustment range of the final transmit power of the terminal, thereby obtaining the adjustment range of the closed-loop power of the terminal.

At operation 204, it is determined whether the target closed-loop power is within the adjustment range of the closed-loop power of the terminal, and in a case where the target closed-loop power is within the adjustment range of the closed-loop power of the terminal, operation 205 is to be performed; and in a case where the target closed-loop power is beyond the adjustment range of the closed-loop power of the terminal, operation 206 is to be performed.

At operation 205, the final transmit power of the terminal is determined to be a sum of the target closed-loop power and the accumulated value of the first other powers.

At operation 206, it is determined whether the target closed-loop power is less than the minimum value of the adjustment range of the closed-loop power of the terminal, and in a case where the target closed-loop power is less than the minimum value of the adjustment range of the closed-loop power of the terminal, operation 207 is to be performed; and in a case where the target closed-loop power is greater than the minimum value of the adjustment range of the closed-loop power of the terminal, operation 208 is to be performed.

At operation 207, a rapid power adjustment amount is determined to be a difference of the minimum value of the adjustment range of the final transmit power of the terminal from a sum of the accumulated value of the first other powers and the closed-loop power; the final transmit power of the terminal is determined to be a sum of the rapid power adjustment amount, the target closed-loop power, and the accumulated value of the first other powers; and a sum of the rapid power adjustment amount and the target closed-loop power is stored.

At operation 208, it is determined whether the target closed-loop power is greater than the maximum value of the adjustment range of the closed-loop power of the terminal, and in a case where the target closed-loop power is less than the maximum value of the adjustment range of the closed-loop power of the terminal, operation 205 is to be performed; and in a case where the target closed-loop power is greater than the maximum value of the adjustment range of the closed-loop power of the terminal, operation 209 is to be performed.

At operation 209, a rapid power adjustment amount is determined to be a difference of the maximum value of the adjustment range of the final transmit power of the terminal from the sum of the accumulated value of the first other powers and the closed-loop power; the final transmit power of the terminal is determined to be a difference of the rapid power adjustment amount from a sum of the target closed-loop power and the accumulated value of the first other powers; and a difference between the rapid power adjustment and the target closed-loop power is stored.

### Example 2

In the present example, a power calculation for a PUSCH is taken as an example to illustrate the power adjustment method provided in the embodiment of the present disclosure, and a power calculation process for the PUSCH is to be under a closed-loop control, so that a final transmit power of the terminal is a sum of a closed-loop power and an accumulated value of first other powers except the closed-loop power.

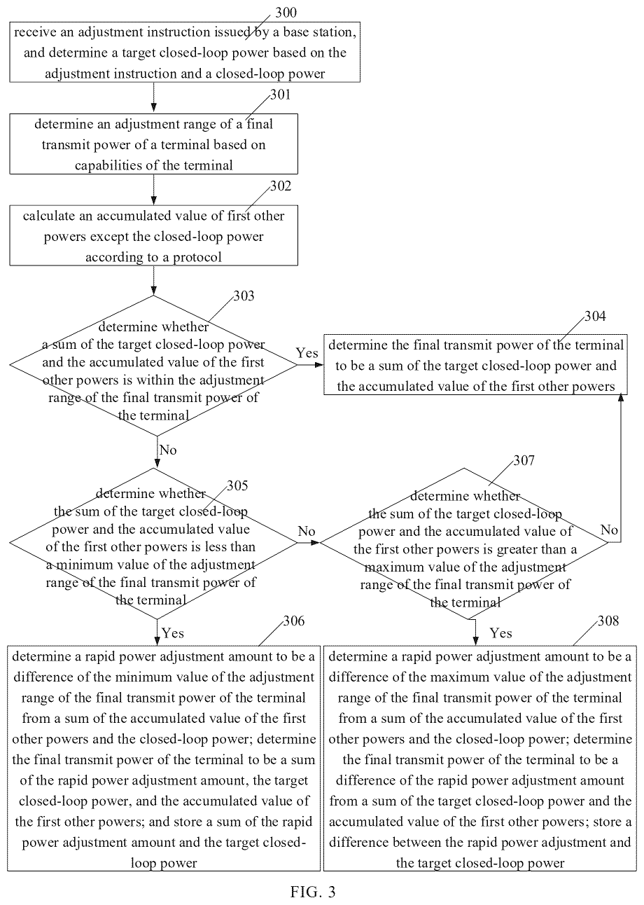

As shown in FIG. 3, a power adjustment procedure for the PUSCH includes the following operations 300 to 309.

At operation 300, an adjustment instruction issued by a base station is received, and a target closed-loop power is determined based on the adjustment instruction and a closed-loop power.

At operation 301, an adjustment range of a final transmit power of a terminal is determined based on capabilities of the terminal.

At operation 302, an accumulated value of first other powers except the closed-loop power is calculated according to a protocol.

At operation 303, it is determined whether a sum of the target closed-loop power and the accumulated value of the first other powers is within the adjustment range of the final transmit power of the terminal, and in a case where the sum of the target closed-loop power and the accumulated value of the first other powers is within the adjustment range of the final transmit power of the terminal, operation 304 is to be performed; and in a case where the sum of the target closed-loop power and the accumulated value of the first other powers is beyond the adjustment range of the final transmit power of the terminal, operation 305 is to be performed.

At operation 304, the final transmit power of the terminal is determined to be a sum of the target closed-loop power and the accumulated value of the first other powers.

At operation 305, it is determined whether the sum of the target closed-loop power and the accumulated value of the first other powers is less than a minimum value of the adjustment range of the final transmit power of the terminal, and in a case where the sum of the target closed-loop power and the accumulated value of the first other powers is less than the minimum value of the adjustment range of the final transmit power of the terminal, operation 306 is to be performed; and in a case where the sum of the target closed-loop power and the accumulated value of the first other powers is greater than the minimum value of the adjustment range of the final transmit power of the terminal, operation 307 is to be performed.

At operation 306, a rapid power adjustment amount is determined to be a difference of the minimum value of the adjustment range of the final transmit power of the terminal from a sum of the accumulated value of the first other powers and the closed-loop power; the final transmit power of the terminal is determined to be a sum of the rapid power adjustment amount, the target closed-loop power, and the accumulated value of the first other powers; and a sum of the rapid power adjustment amount and the target closed-loop power is stored.

At operation 307, it is determined whether the sum of the target closed-loop power and the accumulated value of the first other powers is greater than a maximum value of the adjustment range of the final transmit power of the terminal, and in a case where the sum of the target closed-loop power and the accumulated value of the first other powers is less than the maximum value of the adjustment range of the final transmit power of the terminal, operation 304 is to be performed; and in a case where the sum of the target closed-loop power and the accumulated value of the first other powers is greater than the maximum value of the adjustment range of the final transmit power of the terminal, operation 308 is to be performed.

At operation 308, a rapid power adjustment amount is determined to be a difference of the maximum value of the adjustment range of the final transmit power of the terminal from a sum of the accumulated value of the first other powers and the closed-loop power; the final transmit power of the terminal is determined to be a difference of the rapid power adjustment amount from a sum of the target closed-loop power and the accumulated value of the first other powers; and a difference between the rapid power adjustment and the target closed-loop power is stored.

### Example 3

In the present example, a power calculation for a Packet Random Access Channel (PRACH) is taken as an example to illustrate the power adjustment method provided in the embodiment of the present disclosure, and a power calculation process for the PRACH is not under a closed-loop control, so that the final transmit power of the terminal is a sum of a ramp power and an accumulated value of second other powers except the ramp power.

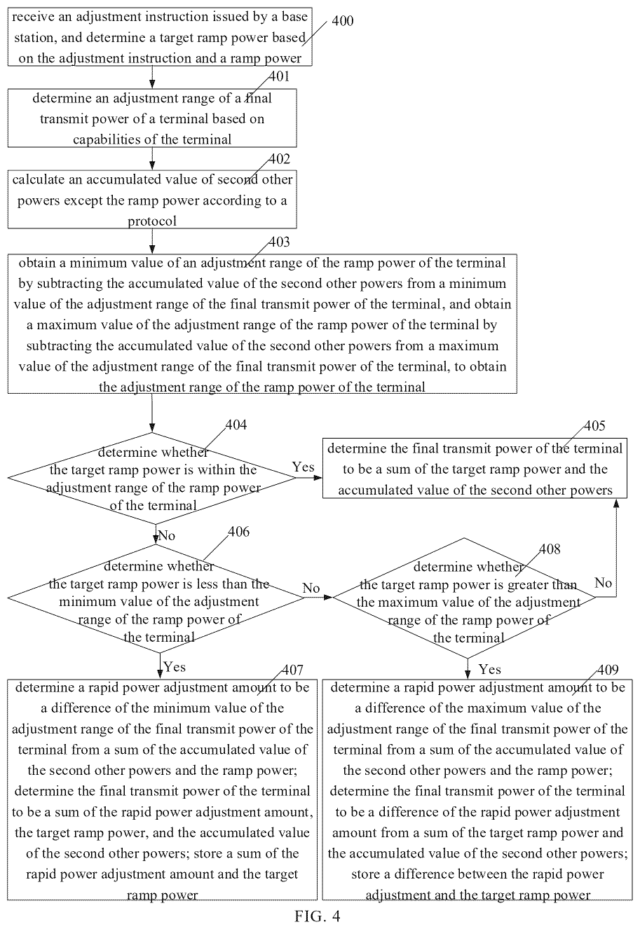

As shown in FIG. 4, a power adjustment procedure for the PRACH includes the following operations 400 to 409.

At operation 400, an adjustment instruction issued by a base station is received, and a target ramp power is determined based on the adjustment instruction and a ramp power.

At operation 401, an adjustment range of a final transmit power of a terminal is determined based on capabilities of the terminal.

At operation 402, an accumulated value of second other powers except the ramp power is calculated according to a protocol.

At operation 403, a minimum value of an adjustment range of the ramp power of the terminal is obtained by subtracting the accumulated value of the second other powers from a minimum value of the adjustment range of the final transmit power of the terminal, and a maximum value of the adjustment range of the ramp power of the terminal is obtained by subtracting the accumulated value of the second other powers from a maximum value of the adjustment range of the final transmit power of the terminal, thereby obtaining the adjustment range of the ramp power of the terminal.

At operation 404, it is determined whether the target ramp power is within the adjustment range of the ramp power of the terminal, and in a case where the target ramp power is within the adjustment range of the ramp power of the terminal, operation 405 is to be performed; and in a case where the target ramp power is beyond the adjustment range of the ramp power of the terminal, operation 406 is to be performed.

At operation 405, the final transmit power of the terminal is determined to be a sum of the target ramp power and the accumulated value of the second other powers.

At operation 406, it is determined whether the target ramp power is less than the minimum value of the adjustment range of the ramp power of the terminal, and in a case where the target ramp power is less than the minimum value of the adjustment range of the ramp power of the terminal, operation 407 is to be performed; and in a case where the target ramp power is greater than the minimum value of the adjustment range of the ramp power of the terminal, operation 408 is to be performed.

At operation 407, a rapid power adjustment amount is determined to be a difference of the minimum value of the adjustment range of the final transmit power of the terminal from a sum of the accumulated value of the second other powers and the ramp power; the final transmit power of the terminal is determined to be a sum of the rapid power adjustment amount, the target ramp power, and the accumulated value of the second other powers; and a sum of the rapid power adjustment amount and the target ramp power is stored.

At operation 408, it is determined whether the target ramp power is greater than the maximum value of the adjustment range of the ramp power of the terminal, and in a case where the target ramp power is less than the maximum value of the adjustment range of the ramp power of the terminal, operation 405 is to be performed; and in a case where the target ramp power is greater than the maximum value of the adjustment range of the ramp power of the terminal, operation 409 is to be performed.

At operation 409, a rapid power adjustment amount is determined to be a difference of the maximum value of the adjustment range of the final transmit power of the terminal from a sum of the accumulated value of the second other powers and the ramp power; the final transmit power of the terminal is determined to be a difference of the rapid power adjustment amount from a sum of the target ramp power and the accumulated value of the second other powers; and a difference between the rapid power adjustment and the target ramp power is stored.

### Example 4

In the present example, a power calculation for a PRACH is taken as an example to illustrate the power adjustment method provided in the embodiment of the present disclosure, and a power calculation process for the PRACH is not under a closed-loop control, so that a final transmit power of the terminal is a sum of a ramp power and an accumulated value of second other powers except the ramp power.

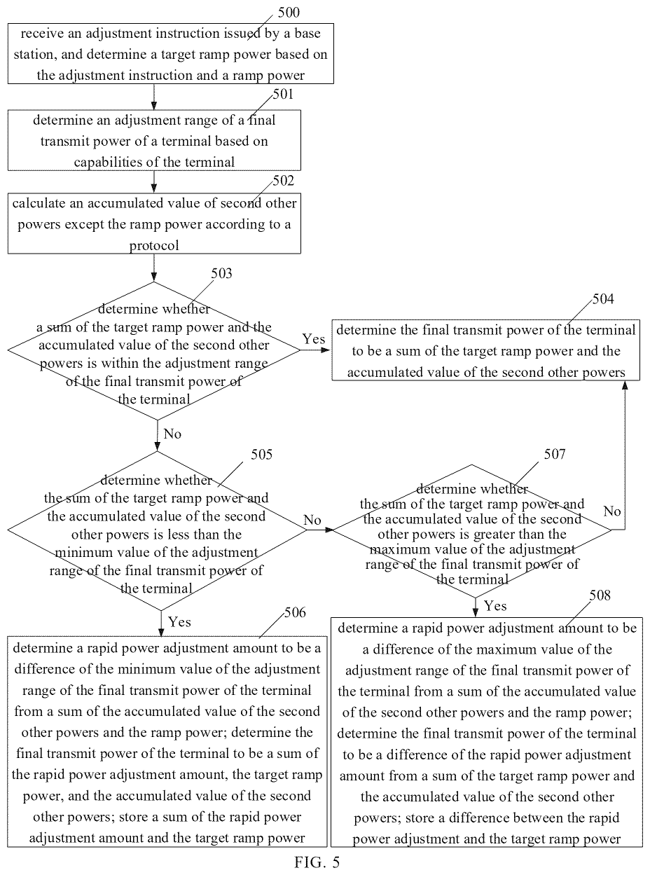

As shown in FIG. 5, a power adjustment procedure for the PRACH includes the following operations 500 to 509.

At operation 500, an adjustment instruction issued by a base station is received, and a target ramp power is determined based on the adjustment instruction and a ramp power.

At operation 501, an adjustment range of a final transmit power of a terminal is determined based on capabilities of the terminal.

At operation 502, an accumulated value of second other powers except the ramp power is calculated according to a protocol.

At operation 503, it is determined whether a sum of the target ramp power and the accumulated value of the second other powers is within the adjustment range of the final transmit power of the terminal, and in a case where the sum of the target ramp power and the accumulated value of the second other powers is within the adjustment range of the final transmit power of the terminal, operation 504 is to be performed; and in a case where the sum of the target ramp power and the accumulated value of the second other powers is beyond the adjustment range of the final transmit power of the terminal, operation 505 is to be performed.

At operation 504, the final transmit power of the terminal is determined to be a sum of the target ramp power and the accumulated value of the second other powers.

At operation 505, it is determined whether the sum of the target ramp power and the accumulated value of the second other powers is less than a minimum value of the adjustment range of the final transmit power of the terminal, and in a case where the sum of the target ramp power and the accumulated value of the second other powers is less than the minimum value of the adjustment range of the final transmit power of the terminal, operation 506 is to be performed; and in a case where the sum of the target ramp power and the accumulated value of the second other powers is greater than the minimum value of the adjustment range of the final transmit power of the terminal, operation 507 is to be performed.

At operation 506, a rapid power adjustment amount is determined to be a difference of the minimum value of the adjustment range of the final transmit power of the terminal from a sum of the accumulated value of the second other powers and the ramp power; the final transmit power of the terminal is determined to be a sum of the rapid power adjustment amount, the target ramp power, and the accumulated value of the second other powers; and a sum of the rapid power adjustment amount and the target ramp power is stored.

At operation 507, it is determined whether the sum of the target ramp power and the accumulated value of the second other powers is greater than a maximum value of the adjustment range of the final transmit power of the terminal, and in a case where the sum of the target ramp power and the accumulated value of the second other powers is less than the maximum value of the adjustment range of the final transmit power of the terminal, operation 504 is to be performed; and in a case where the sum of the target ramp power and the accumulated value of the second other powers is greater than the maximum value of the adjustment range of the final transmit power of the terminal, operation 508 is to be performed.

At operation 508, a rapid power adjustment amount is determined to be a difference of the maximum value of the adjustment range of the final transmit power of the terminal from a sum of the accumulated value of the second other powers and the ramp power; the final transmit power of the terminal is determined to be a difference of the rapid power adjustment amount from a sum of the target ramp power and the accumulated value of the second other powers; and a difference between the rapid power adjustment and the target ramp power is stored.

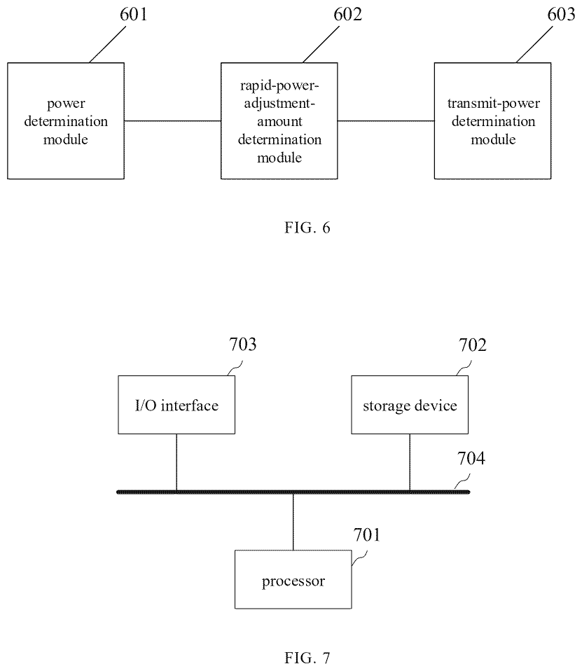

FIG. 6 is a block diagram of a power adjustment apparatus according to an embodiment of the present disclosure.

In a second aspect, referring to FIG. 6, an embodiment of the present disclosure provides a power adjustment apparatus, including: a power determination module 601, configured to receive an adjustment instruction issued by a base station, and determine a target first power based on the adjustment instruction and a first power of a terminal; a rapid-power-adjustment-amount determination module 602, configured to determine a second power of the terminal, determine whether a third power of the terminal is within a limitation range based on the target first power and the second power, and determine, in a case where the third power is beyond the limitation range, a rapid power adjustment amount based on an adjustment range of a final transmit power of the terminal, the first power, and the second power; and a transmit-power determination module 603, configured to determine the final transmit power of the terminal based on the rapid power adjustment amount, the target first power, and the second power, so as to enable the final transmit power to be within the adjustment range of the final transmit power.

In some exemplary implementations, the rapid-power-adjustment-amount determination module 602 is configured to determine whether the third power of the terminal is within the limitation range based on the target first power and the second power by: determining the limitation range based on the second power and the adjustment range of the final transmit power of the terminal; and determining whether the target first power is within the limitation range.

In some exemplary implementations, the rapid-power-adjustment-amount determination module 602 is configured to determine the limitation range based on the second power and the adjustment range of the final transmit power of the terminal by: determining a minimum value of the limitation range to be a difference between a minimum value of the adjustment range of the final transmit power of the terminal and the second power, and determining a maximum value of the limitation range to be a difference between a maximum value of the adjustment range of the final transmit power of the terminal and the second power.

In some exemplary implementations, the rapid-power-adjustment-amount determination module 602 is configured to determine whether the third power of the terminal is within the limitation range based on the target first power and the second power by: determining the third power based on the target first power and the second power; and determining whether the third power is within the limitation range.

In some exemplary implementations, the rapid-power-adjustment-amount determination module 602 is configured to determine the rapid power adjustment amount based on the adjustment range of the final transmit power of the terminal, the first power, and the second power by: determining the rapid power adjustment amount to be a difference of the minimum value of the adjustment range of the final transmit power of the terminal from a sum of the first power and the second power.

The transmit-power determination module 603 is configured to determine the final transmit power of the terminal based on the rapid power adjustment amount, the target first power, and the second power by: determining the final transmit power of the terminal to be a sum of the rapid power adjustment amount, the target first power, and the second power.

In some exemplary implementations, the rapid-power-adjustment-amount determination module 602 is configured to determine the rapid power adjustment amount based on the adjustment range of the final transmit power of the terminal, the first power, and the second power by: determining the rapid power adjustment amount to be a difference of the maximum value of the adjustment range of the final transmit power of the terminal from a sum of the first power and the second power.

The transmit-power determination module 603 is configured to determine the final transmit power of the terminal based on the rapid power adjustment amount, the target first power, and the second power by: determining the final transmit power of the terminal to be a difference of the rapid power adjustment amount from a sum of the target first power and the second power.

In some exemplary implementations, the second power is an accumulated value of first other powers except a closed-loop power, the first power is the closed-loop power, and the target first power is a target closed-loop power.

In some exemplary implementations, the second power is an accumulated value of second other powers except a ramp power, the first power is the ramp power, and the target first power is a target ramp power.

In some exemplary implementations, the third power is the target closed-loop power, and the limitation range is an adjustment range of the closed-loop power.

In some exemplary implementations, the third power is the target ramp power, and the limitation range is an adjustment range of the ramp power.

In some exemplary implementations, the third power is a sum of the target first power and the second power, and the limitation range is the adjustment range of the final transmit power of the terminal.

Specific implementations of the power adjustment apparatus are the same as the specific implementations of the power adjustment method provided in the embodiment described above, and thus will not be repeated here.

In a third aspect, referring to FIG. 7, an embodiment of the present disclosure provides an electronic device, including: at least one processor 701; and a storage device 702 having stored thereon at least one computer program which, when executed by the at least one processor 701, causes the at least one processor 701 to implement the power adjustment method described above.

In some exemplary implementations, the electronic device further includes at least one Input/output (I/O) interface 703 connected between the processor 701 and the storage device 702 and configured to enable information interaction between the processor 701 and the storage device 702.

The processor 701 is a device having a data processing capability, and includes, but is not limited to, a Central Processing Unit (CPU); the storage device 702 is a device having a data storage capability, and includes, but is not limited to, a Random Access Memory (RAM, more specifically, a Synchronous Dynamic RAM (SDRAM), a Double Data Rate SDRAM (DDR SDRAM), etc.), a Read-Only Memory (ROM), an Electrically Erasable Programmable Read-Only Memory (EEPROM), and a flash memory (FLASH); and the I/O interface (read/write interface) 103 is connected between the processor 701 and the storage device 702, is capable of enabling the information interaction between the processor 701 and the storage device 702, and includes, but is not limited to, a data bus (Bus).

In some exemplary implementations, the processor 701, the storage device 702, and the I/O interface 703 are connected to each other through a bus 704, and then are connected to other components of a computing device.

In a fourth aspect, an embodiment of the present disclosure provides a computer-readable storage medium having stored thereon a computer program which, when executed by a processor, causes the processor to implement the power adjustment method described above.

It should be understood by those of ordinary skill in the art that all or some of the operations in the method, the functional modules/units in the system or device disclosed above may be implemented as software, firmware, hardware, or suitable combinations thereof. If implemented as hardware, the division between the functional modules/units stated above does not necessarily correspond to the division of physical components; for example, one physical component may have a plurality of functions, or one function or operation may be performed through a cooperation of several physical components. Some or all of the physical components may be implemented as software executed by a processor, such as a CPU, a digital signal processor or a microprocessor, or may be implemented as hardware, or may be implemented as an integrated circuit, such as an application specific integrated circuit. Such software may be distributed on a computer-readable medium, which may include a computer storage medium (or a non-transitory medium) and a communication medium (or a transitory medium). As well known by those of ordinary skill in the art, the term “computer storage medium” includes volatile/nonvolatile and removable/non-removable medium used in any method or technology for storing information (such as computer-readable instructions, data structures, program modules or other data). The computer storage medium includes, but is not limited to, an RAM, an ROM, an EEPROM, a flash memory or other memory techniques, a Compact Disc Read Only Memory (CD-ROM), a Digital Versatile Disc (DVD) or other optical discs, a magnetic cassette, a magnetic tape, a magnetic disk or other magnetic storage devices, or any other medium which can be configured to store desired information and can be accessed by a computer. In addition, it is well known by those of ordinary skill in the art that the communication medium generally includes computer-readable instructions, data structures, program modules, or other data in modulated data signals such as carriers or other transmission mechanisms, and may include any information delivery medium.

The present disclosure discloses the exemplary embodiments using specific terms, but the terms are merely used and should be merely interpreted as having general illustrative meanings, rather than for the purpose of limitation. Unless expressly stated, it is apparent to those of ordinary skill in the art that the features, characteristics and/or elements described in connection with a particular embodiment can be used alone or in combination with the features, characteristics and/or elements described in connection with other embodiments. Therefore, it should be understood by those of ordinary skill in the art that various changes in forms and details can be made without departing from the scope of the present disclosure as defined by the appended claims.

1. A power adjustment method, comprising:
receiving an adjustment instruction issued by a base station, and determining a target first power based on the adjustment instruction and a first power of a terminal;
determining a second power of the terminal; determining whether a third power of the terminal is within a limitation range based on the target first power and the second power; and in response to the third power going beyond the limitation range, determining a rapid power adjustment amount based on an adjustment range of a final transmit power of the terminal, the first power, and the second power; and
determining the final transmit power of the terminal based on the rapid power adjustment amount, the target first power, and the second power, so as to enable the final transmit power to be within the adjustment range of the final transmit power.

2. The power adjustment method of claim 1, wherein determining whether the third power of the terminal is within the limitation range based on the target first power and the second power comprises:
determining the limitation range based on the second power and the adjustment range of the final transmit power of the terminal; and
determining whether the target first power is within the limitation range.

3. The power adjustment method of claim 2, wherein determining the limitation range based on the second power and the adjustment range of the final transmit power of the terminal comprises:
determining a minimum value of the limitation range to be a difference between a minimum value of the adjustment range of the final transmit power of the terminal and the second power, and determining a maximum value of the limitation range to be a difference between a maximum value of the adjustment range of the final transmit power of the terminal and the second power.

4. The power adjustment method of claim 1, wherein determining whether the third power of the terminal is within the limitation range based on the target first power and the second power comprises:
determining the third power based on the target first power and the second power; and
determining whether the third power is within the limitation range.

5. The power adjustment method of claim 1, wherein determining the rapid power adjustment amount based on the adjustment range of the final transmit power of the terminal, the first power, and the second power comprises: determining the rapid power adjustment amount to be a difference of a minimum value of the adjustment range of the final transmit power of the terminal from a sum of the first power and the second power; and
determining the final transmit power of the terminal based on the rapid power adjustment amount, the target first power, and the second power comprises: determining the final transmit power of the terminal to be a sum of the rapid power adjustment amount, the target first power, and the second power.

6. The power adjustment method of claim 1, wherein determining the rapid power adjustment amount based on the adjustment range of the final transmit power of the terminal, the first power, and the second power comprises: determining the rapid power adjustment amount to be a difference of a maximum value of the adjustment range of the final transmit power of the terminal from a sum of the first power and the second power; and
determining the final transmit power of the terminal based on the rapid power adjustment amount, the target first power, and the second power comprises: determining the final transmit power of the terminal to be a difference of the rapid power adjustment amount from a sum of the target first power and the second power.

7. The power adjustment method of claim 1, wherein the second power is an accumulated value of first other powers except a closed-loop power, the first power is the closed-loop power, and the target first power is a target closed-loop power; or
the second power is an accumulated value of second other powers except a ramp power, the first power is the ramp power, and the target first power is a target ramp power.

8. The power adjustment method of claim 7, wherein the third power is the target closed-loop power, and the limitation range is an adjustment range of the closed-loop power; or
the third power is the target ramp power, and the limitation range is an adjustment range of the ramp power; or
the third power is a sum of the target first power and the second power, and the limitation range is the adjustment range of the final transmit power of the terminal.

9. A power adjustment apparatus, comprising:
a power determination module, configured to receive an adjustment instruction issued by a base station, and determine a target first power based on the adjustment instruction and a first power of a terminal;
a rapid-power-adjustment-amount determination module, configured to determine a second power of the terminal, determine whether a third power of the terminal is within a limitation range based on the target first power and the second power, and determine, in response to the third power going beyond the limitation range, a rapid power adjustment amount based on an adjustment range of a final transmit power of the terminal, the first power, and the second power; and
a transmit-power determination module, configured to determine the final transmit power of the terminal based on the rapid power adjustment amount, the target first power, and the second power, so as to enable the final transmit power to be within the adjustment range of the final transmit power.

10. An electronic device, comprising:
at least one processor; and
a storage device having stored at least one computer program which, when executed by the at least one processor, causes the at least one processor to implement a power adjustment method, the power adjustment method comprises:
receiving an adjustment instruction issued by a base station, and determining a target first power based on the adjustment instruction and a first power of a terminal;
determining a second power of the terminal; determining whether a third power of the terminal is within a limitation range based on the target first power and the second power; and in response to the third power going beyond the limitation range, determining a rapid power adjustment amount based on an adjustment range of a final transmit power of the terminal, the first power, and the second power; and
determining the final transmit power of the terminal based on the rapid power adjustment amount, the target first power, and the second power, so as to enable the final transmit power to be within the adjustment range of the final transmit power.

11. A non-transitory computer-readable medium having stored a computer program which, when executed by a processor, causes the processor to implement the power adjustment method of 1.

12. The power adjustment method of claim 2, wherein the second power is an accumulated value of first other powers except a closed-loop power, the first power is the closed-loop power, and the target first power is a target closed-loop power; or
the second power is an accumulated value of second other powers except a ramp power, the first power is the ramp power, and the target first power is a target ramp power.

13. The power adjustment method of claim 4, wherein the second power is an accumulated value of first other powers except a closed-loop power, the first power is the closed-loop power, and the target first power is a target closed-loop power; or
the second power is an accumulated value of second other powers except a ramp power, the first power is the ramp power, and the target first power is a target ramp power.

14. The power adjustment method of claim 5, wherein the second power is an accumulated value of first other powers except a closed-loop power, the first power is the closed-loop power, and the target first power is a target closed-loop power; or
the second power is an accumulated value of second other powers except a ramp power, the first power is the ramp power, and the target first power is a target ramp power.

15. The power adjustment method of claim 6, wherein the second power is an accumulated value of first other powers except a closed-loop power, the first power is the closed-loop power, and the target first power is a target closed-loop power; or
the second power is an accumulated value of second other powers except a ramp power, the first power is the ramp power, and the target first power is a target ramp power.

16. The power adjustment method of claim 12, wherein the third power is the target closed-loop power, and the limitation range is an adjustment range of the closed-loop power; or
the third power is the target ramp power, and the limitation range is an adjustment range of the ramp power; or
the third power is a sum of the target first power and the second power, and the limitation range is the adjustment range of the final transmit power of the terminal.

17. The power adjustment method of claim 13, wherein the third power is the target closed-loop power, and the limitation range is an adjustment range of the closed-loop power; or
the third power is the target ramp power, and the limitation range is an adjustment range of the ramp power; or
the third power is a sum of the target first power and the second power, and the limitation range is the adjustment range of the final transmit power of the terminal.

18. The power adjustment method of claim 14, wherein the third power is the target closed-loop power, and the limitation range is an adjustment range of the closed-loop power; or
the third power is the target ramp power, and the limitation range is an adjustment range of the ramp power; or
the third power is a sum of the target first power and the second power, and the limitation range is the adjustment range of the final transmit power of the terminal.

19. The power adjustment method of claim 15, wherein the third power is the target closed-loop power, and the limitation range is an adjustment range of the closed-loop power; or
the third power is the target ramp power, and the limitation range is an adjustment range of the ramp power; or
the third power is a sum of the target first power and the second power, and the limitation range is the adjustment range of the final transmit power of the terminal.

20. The power adjustment method of claim 7, wherein, for determining the final transmit power of the terminal in a physical uplink shared channel, the second power is an accumulated value of first other powers except a closed-loop power, the first power is the closed-loop power, and the target first power is a target closed-loop power;
for determining the final transmit power of the terminal in a packet random access channel, the second power is an accumulated value of second other powers except a ramp power, the first power is the ramp power, and the target first power is a target ramp power.
